(19) United States
(12) Patent Application Publication
(10) Pub. No.: US 2003/0155469 A1
(43) Pub. Date: Aug. 21, 2003

(54) Flying object with a rotational effect

(76) Inventor: Srecko Ugrin, Belgrade (YU)

Correspondence Address: John S. Egbert, Harrison & Egbert, 412 Main Street, 7th Floor, Houston, TX, 77002, US

(21) Appl. No.: 10/354,059

(22) Filed: Jan. 29, 2003

Related U.S. Application Data
(63) Continuation-in-part of application No. 10/092,671, filed on Mar. 7, 2002, now abandoned.
Application No. 10/092,671 is a continuation-in-part of application No. 09/601,268, filed on Jul. 29, 2000, now abandoned.
Application No. 09/601,268 is a 371 of international application No. PCT/YU98/00013, filed on Apr. 8, 1998.

(51) Int. Cl. B64G 1/62

(52) U.S. Cl. 244/161

(57) ABSTRACT

A flying object with a rotational effect including a base, eight wheels suitable for starting and landing the flying object, a platform, a cover, a bearing frame for shaft, an engine for rotation, a jet engine for starting, flying and landing the flying object, and an outlet of the jet engine.

### RELATED U.S. APPLICATIONS

The present invention is a further continuation-in-part of co-pending application, U.S. Ser. No. 10/092,671, filed on Mar. 7, 2002, entitled “FLYING OBJECT WITH A ROTATIONAL EFFECT”, which is a continuation-in-part of U.S. Ser. No. 09/601,268, filed on Jul. 29, 2000.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention belongs to the field of flying and to flying objects driven by an engine and used for transport of people and loads and for other purposes. It relates to achievement of effects in tremendously increasing velocity, in minimizing spending of energy, in increasing capability for loading and in enlarging a moved distance without landing.

### BACKGROUND OF THE INVENTION

The invention solves four main problems which are present in functioning the flying objects driven by engine:

1) a significant reduction of energy spent in motion,

2) an enormous increase of speed,

3) considerable enlargement of rate of loading (a weight of embarked objects and part of a weight related to a crew and a passengers),

4) an increase of a distance moved with landing-no, which is achieved both on the basis of extension of a capacity for storing fuel, and on the basis of remarkable low quantities of spent energy.

The advantages of the invention presented above in four points constitute in the same time four main characteristics of efficiency of the invention.

The construction of the contemporary kinds of aircraft driven by engines is based on effects of a jet engine and on effects of rotating propellers.

The parts of the body of a contemporary aircraft remain in fixed position during a flying. The body of the aircraft connects all walls of the aircraft and volume closed by them which is suitable for placement of an engine, other technical devices, a load and accommodation of a crew and a passengers. The body does not include propellers and a stream of a jet engine. The body remains in fixed position during flying, i.e. no one part of the body changes position during the flight related to its other parts or related to things located within it while they are not in movement. This fixed position of the body represents an essential constitutive characteristic of the aircraft.

The flying object consists of one or more rotating bodies placed in it that rotates during flight.

This rotation provides rotational effect. Laws concerning rotational effect are explained in the following exposition. The main substance of them is rule that resultant vector of rotating body is oriented opposite to direction of flying. The same effect appears in other kind of motion of means with such functions and attributes of rotating bodies in them.

Advantages of invention are not based on main valid theories of physics. They can not be explained by fundamental definitions of contemporary physics. Therefore, the invention can be carried out and it can be made, i.e. it can be used by observing theoretical base exposed here and presented in the printed matter “Fundamental of Physics are out of Date and Wrong” written from the applicant of the invention. Only outline of theoretical essence of new laws of physics on which the invention is based is presented through explications given in a text that follows. In this way, several further expositions constitute description of essential theoretical points related to manner and process of making and using invention.

Efficiency of flying object results from decrease of influence of gravitational attraction, i.e. gravity on flying object and from lessened influence of gravitational attraction on rotating body or two or more rotating bodies placed within flying object. The effect of lessening of gravitational attraction is enlarged when significant velocity of rotation from one or on two or on more rotational bodies is reached. Therefore, velocity of rotation will be always considered with respective magnitude when appearance of rotational effect is comprised. The motion of the flying object has to be directed in a way that lessening of gravitational attraction effects improvement of flight, i.e in accordance with direction of resultant vector originated from vector symbolized centrifugal force of rotating body.

In this text of application terms of horizontal or vertical line and other lines, i.e. positions in motion, are defined proceeding from definition of vertical line that indicates line positioned downwards to the horizon, i.e. in direction of action of gravitational attraction and by horizontal line that closes right angle with this vertical line and with a radius of earth. Surfaces laid between horizontal lines or between vertical lines are defined as horizontal and vertical surfaces. When surface is not horizontal or vertical it is defined as inclined surface. It deviates from vertical or horizontal surface.

Horizontal line will be viewed here in horizontal and in vertical surface.

The invention is based on the following experiment:

A body is laid on a flat surface of some inelastic material with small thickness and it is attracted with magnetism produced by a magnet positioned under and close to this flat surface. A motion of a body can appear only under fulfillment of condition that an external force is applied upon this body. If this force is mechanical with appropriate quantity that is less than it is a quantity of attraction of magnetism the motion will not appear. If it is greater of it the motion will be present. When the body has come out of the field of magnetism it is obvious that this attraction of magnetism ceases to act on the body. But, it is necessary to bear in mind that required magnitude of the mechanical external force applied on the body located in the field of magnetism has to be determined by two criterions. Its quantity must be determined taking into account both quantity of magnetism and quantity of attraction of gravity, i.e. with both kind of attraction. For motion of the body that is not under influence of attraction of magnetism (i.e. when it is out of influence of magnetic field) it is enough to calculate the force that is in proportion with attraction of gravity. If the force is less of it the motion will not appear. If the force is greater of it the motion will be present. If quantity of the mechanical force is considerably greater than quantity of attraction of gravity the body will be in greater extent released from influence of attraction of gravity. This conclusion is based on relations between appropriate vectors.

Two main new laws have to be taken into consideration. They are:

a. A body at rest can begin its own motion in any direction than downwards in vertical line after accomplishment of condition that vector of a net force applied on it is greater than vector representing influence of attraction of gravity on it.

b. Lessening of attraction of gravity on the body emerges from moment when a motion begins in any direction than downwards in vertical line. This lessening of influence of gravitational attraction continues rapidly with enlargement of velocity. The effect of lessening of gravitational attraction appears when vector of this velocity prevails upon vector of gravitational attraction. With magnifying vector of the velocity and with causing in this way reduction of vector of gravitational attraction this effect becomes increased. Mass of moving body becomes, in this case, under lessened influence of gravitational attraction. This effect appears in direction of motion.

Motion in straight horizontal line will be mostly taken into consideration in all respective cases of presentation of motion. Force will be considered in new way in this text of application so that it constitutes product of mass and final reached velocity. The final value of velocity is observed as only relevant magnitude for real presentation of force.

One of basic laws of valid physics is: the more mass (m) a body has, the less its acceleration (a) when a net force acts on it. Consequently, this law can be presented in the following form: “A reduction of mass is the only way to ‘counter’ the force of gravity.”

It is evident that mass of body represents vector of gravitational attraction. This statement is not expressed by definitions of valid physics. Contrary to that weight is expressed with product of mass (m) and gravitational acceleration (g). It is also evident that mass (m) and gravitational acceleration (g) are categories for exposition natural phenomenon known as gravitational attraction. A force generated in first second from falling body from rest is also defined in valid physics with product of mass (m) and gravitational attraction (g). But, weight and this kind of the force are not of a same value. Weight presented with “mg” and the force also expressed with “mg” have different magnitudes. A stationary body can begin to move in case when the net force applied on it is smaller of quantity of weight. But, the stationary body will begin to move if the net force applied on it is greater than mass of the body and less of weight, i.e. when m<ma<mg. This relation between the force (ma) and mass (m) is not comparable by laws of valid physics, i.e. not by comparison between “m” and “ma”. These values are not comparable by numerical magnitudes and by appropriate units. The invention of the applicant results from this relation and it is necessary to take it in consideration. The applicant had enclosed a printed matter with presentation of new definitions of physics laws in which this relation is exactly described. But, action of these two vectors, from which one represents force and another one represents mass, exists in practice. This relation can be recognized without theoretical explanation of relation between force and mass. Force and mass can act to each other in real life. The final values of forces are determined in quantities of mass. Force acts from one mass to another mass. Therefore resultant vector of force must be viewed by quantity of mass. In this respect it is necessary to take into consideration that pressure of stationary body is in direct proportion with magnitude of mass. Increase of mass of body acting within force and with unchanged final velocity enlarges its pressure in all directions of actions. Contrary, it is not possible to increase in all cases real force in proportion with increase of velocity. Force with unchanged final velocity can be increased in exact proportion with enlargement of mass by which it acts. Therefore, this enlargement is not expressed regularly by product of unit of mass and unit of velocity. In accordance to that mass is final form in reality of forces. Greater mass indicates greater effect of motion. Quantities of masses are final manifestations of forces. Velocity transfers its value to mass of body. Stationary body of 1 kg mass delivers pressure of 1 kg on unit of area and force of 1 kg mass and of final velocity of 0.2 m/s delivers pressure of more than 1 kg. In the text of application power is also defined with the same categories by which force is defined. Power is product of mass and final velocity. Force arises by one action or by many actions of power, i.e. by one delivery of power or by its iterations and multiplication when it acts more than once.

The body at rest produces pressure on horizontal or on inclined surfaces of inclined plane, on which it lays, and this pressure appears from influence of gravitational attraction. This pressure demonstrates vector of mass of body. This is in accordance with the statement: “A reduction of mass is the only way to ‘counter’ the force of gravity.” Mass and weight must be expressed in kilograms. During motion this pressure disappears in proportion with enlargement of velocity. Two vectors are present from which one relates to attraction of gravity expressed by vector acting in imagined vertical line and another one relates to velocity of body which decisively influences direction of motion. Resultant vector is between them. When resultant vector arisen from velocity and gravitational attraction dominantly originates from vector representing velocity in this moment intensity of vector expressed by pressure on surface is remarkably diminished. In motion in horizontal straight-line resultant vector closes angle with velocity. This angle indicates retention of influence of gravitational attraction on body and appearance of fraction of friction exerted from existing participation of influence of gravitational attraction on body. The greatest part of influence of gravitational attraction can be annulled by velocity. But, there is no net force applied on body that can provide continually horizontal straight motion in a way that influence of vector belonging to gravitational attraction can be totally annulled in whole motion. It is obvious that it is not exact physical law determined in valid physics from Isaac Newton (1672-1727) which words: “Unless acted upon by a net force, a body continues moving at the same speed in the same direction.” There is no such force acting on a body, i.e. the net force by which it is possible totally to annul influence of gravitational attraction. Therefore, resultant vector does not exist in straight horizontal line but in curved line. Speed of motion decreases gradually in accordance with action of vector representing attraction of gravity.

When body falls down through vertical line there is no presence of two directions and two appropriate vectors with different directions of action and there is no resultant vector out of vertical line. Direction of motion coincides with direction in which gravitational attraction acts. Therefore this direction of velocity is not observed in this text of application. There is no decrease of gravitational attraction when velocity is directed in direction of action of gravitational attraction.

Attained velocity of moving body is expression of lessening of influence of attraction of gravity on the body. As influence of attraction of gravity acts on body it is obvious that it acts on its mass. Considering that the body is released from influence of attraction of gravity in proportion with its achieved velocity it means that influence of attraction of gravity acting on the mass is lessened when its velocity is increased. During motion mass of the body remains unchanged but influence of attraction of gravity on mass depends of velocity of the body. This statement will be presented observing motion in horizontal straight line.

In valid physics it is said: “The more mass a body has, the less its acceleration when a net force acts on it”. This definition can be interpreted in the following way: Quantity of mass is in all cases measure of influence produced from attraction of gravity. Definition of relation between motion and attraction of gravity is not presented in valid physics correctly. This inaccuracy is expressed by the second law of motion. It words: “A net force applied to a body gives it a rate of change of momentum proportional to the force and in direction of the force.” It is neglected truth that for stationary body one kind of this proportion is valid and for moving body another kind of the proportion is relevant. For example, to get momentum of stationary body of 1 kg2 m/s it is necessary to apply greater force than to increase momentum of moving body from 1 kg30 m/s to 1 kg32 m/s. It is easier to draw a carriage in motion than the carriage staying at rest.

In order to quantify participation of influence from gravitational attraction in every direction of motion it is necessary to come from achieved velocity in motion as criteria for determination of extent by which body is released from attraction of gravity. As it is said this degree depends of relations between two vectors, i.e. between

a. vector representing attraction of gravity

b. vector representing velocity of moving body.

As gravitational acceleration is given per second, in accordance to that, velocity will be also viewed per second. As it is mentioned horizontal straight line will be observed since relation between mentioned vectors is clearly exposed in this direction of motion. Resultant vector is between them as it depicted in FIG. 1.

When v=0 gravitational attraction is 100%. When v≠0 gravitational attraction is lessened.

A rate of lessening is determined by relative value of angle closed between vector v and resultant vector. This angle α is presented on FIG. 2.

With maximum angle α of 90° velocity, v=0. When this angle α is smaller of 90° velocity must be greater of zero. Attained velocity of the body is essential factor for lessening influence of gravitational attraction on the body and the following relation is present:

$${A}_{g} = \frac{α}{90 °} m$$

where: A_{g}=attraction of gravity, m=mass of body.

Angle α is defined with

$$tgα = \frac{g}{v}$$

For example, when v=50 m/s

$$tgα = \frac{g}{v} = \frac{9.81}{50} = 0.196 ;$$

α=11°

$${A}_{g} = \frac{11 °}{90 °} m = 0.12 m$$

With velocity of 50 m/s only 0.12 of mass of moving body is attracted by gravity.

This result relates to motion in horizontal straight line. For motions in other directions these results must be accordingly adjusted toward appropriate angles of motions. But, it is necessary to have in view that mass of moving body acts in direction of motion. It does not act in opposite direction. Even when velocity is smallest mass of body does not act in direction opposite to this motion. This simple statement, obvious by itself, is important for further presentation of advantages of the invention.

Lessening of influence of gravitational attraction appears also in rotation of rotational body. This lessening originates from volume of velocity of rotation. Its manifestation is not the same as it is in motion, i.e. in motion in straight line. In this respect rotational body is viewed in form of disk, i.e. in form of flat circular plate. It rotates about an axle, i.e. with hub or shaft, positioned in center of circle that is imaginable through shape of flat circular plate. As rotating body rotates in position that its all diameters are laid at one surface, this surface is defined as rotational surface. In some cases it is defined as horizontal surface or vertical surface or inclined surface depending of its position is space.

Rotating body produces centrifugal force by velocity of every point of rotating body. Velocities of points located on rotating body constitute centrifugal force. Every part of rotating body has tendency to set aside from rotating body. But, if its particles are linked strongly enough to each other all vectors will produce centrifugal force within rotating body. When rotating body is in horizontal surface all vector of centrifugal force will be aimed in different directions. Rotating body is in horizontal surface when circle imaginable in shape of circular plate is in horizontal surface and when shaft for rotation positioned within this center is in vertical line. But, when rotating body is in inclined surface or in vertical surface resultant vectors will be aimed in one side of rotational surface. As the invention is primarily based on effects produced from rotating body positioned in vertical and inclined surface its resultant vector is depicted in FIG. 3 in vertical surface.

An arrow indicated with “a” represents direction of rotation. An arrow indicated with “b” represents resultant vector. It represents in the same time vector of centrifugal force from such rotating body that is placed in vertical surface. It appears in case when magnitude of velocity per second of rotating body is significantly greater of magnitude of gravitational acceleration. In fact resultant vector is not in one line. It is in many lines and they are placed on surface in accordance with presentation on FIG. 4. In fact many layers of surfaces are present in it. But, these vectors will be called as one resultant vector. An arrow presented by letter “a” relates to direction of rotation of rotational body and an arrow presented by letter “b” shows direction of action of resultant vector. This resultant vector presented in FIG. 4 appears as result of position of vectors by which is produced. Half of points of rotating body will move up by action of force with appropriate angles toward vertical line and they will compel another half of points to follow the action by which they are moved. This another half of points are in dependable and in inactive function. Gravitational attraction acts down in vertical line. Resultant vector is in horizontal line of this vertical surface. It is denoted by direction parallel to tendency of motion of point on top of vertical line. Magnitude of this vector is in proportion with velocity of rotating body. Motion in direction marked by “b” arises from velocity of motion present in direction marked by “a”. This proportion can be expressed in different technical ways but also by using velocity of point at end of length of radius or of point in middle length of radius of rotating body. This indication will be used in further presentation of rotation effect.

Attributes of resultant vector of rotating body are obvious with observing functions of a mechanical gyroscope, i.e. the gyroscope presented by FIG. 5 that works by handy manipulation. In this purpose an experiment will be made. Main parts of this gyroscope are a connecting bar and a rotating body and a weight. The rotating body is placed on one side and the weight on another side of the connecting bar. The connecting bar can move freely up and down and left and right. The weight can be displaced from one place to another place in one side of the connecting bar. The rotational body is not movable on the connecting bar. Juncture between the bar and a vertical stand provides these kinds of moves of the connecting bar. The rotational body rotates about a separate shaft that it is not depicted in FIG. 5 for clearer presentation of essential relations in function of gyroscope in Figure. In the experiment depicted in FIG. 5 the connecting bar is positioned in horizontal line. Balance is reached by placing the weight on appropriate place. The next step is to rotate rotational body sufficiently enough. After that it is possible to notice that the connection bar will move in direction in which resultant vector is aimed. It will move in horizontal surface in direction depicted by FIG. 4. The connecting bar will move obviously with all devices that are on it, i.e. with the rotating body and with the weight. Direction of motion of the connection bar confirms direction in which resultant vector acts. Resultant vector acts in accordance with presentation on FIG. 3 and FIG. 4. This experiment is made by using an educational device produced from Leybold, Germany. Rotation of the rotational body is provoked by winding up string on the shaft (that is not presented in FIG. 5) and by pulling it.

Presented actions of rotating body in direction in which resultant vector is aimed enables perception of origin for two effects appeared by rotating body. These effects are: a) power for blocking angle of rotation, b) convenience in motion from presence of rotation.

Effect of power for blocking angle of rotational surface arises by rotation. It blocks angle of rotation. It will be presented by functions of gyroscope used in one army rocket. It is presented in FIG. 6.

Its main parts are: a rotational body and a case in which rotating body rotates and a connecting bar. The connecting bar is presented in FIG. 6 with line stretched between two walls. These walls belong to body of rocket. A rotational body in function rotates around a shaft which is presented in FIG. 6 along vertical line and which is named here as “the shaft”. The connecting bar is reposed in two holes made in walls. It can move freely in these holes. In this way the gyroscope body includes the rotational body, the case in which the rotating body rotates, the shaft and the connecting bar. In this way the case of gyroscope with the rotational body and with the shaft is suspended on the connecting bar. The gyroscope body can move forward and back and this kind of motion is similar to motion existing at swing. The body of the gyroscope will be considered that it is in horizontal surface when “the shaft” is in vertical line. The rotating body has mass of about 60 grams and the whole body of gyroscope has mass of about 350 grams. (This gyroscope is not available to anybody out of the Army and its mass and their dimensions could not be described exactly). Although rotating body has mass of about 60 grams it produces very strong resultant vector so that it effects mass of the whole body of gyroscope (of about 350 grams). With effects of rotating body the whole body of gyroscope remains in unchanged and fixed position (angle) during fly, i.e. in position in which it was in the beginning of rotation of rotational body. This fixed position can belong to inclined surface or horizontal surface. The vertical surface is excluded from observations. But, “the shaft” can be in horizontal or inclined surface, i.e. even in vertical surface. If rocket takes new position during fly, i.e. if it changes position from position present at start of fly, the body of gyroscope will remain in the same surface as it was taken during appropriate rotation of rotational body. If this position produced from the rotating body is starting position, i.e. if it is given in advance as chosen surface, it will stay in this position during motion regardless of line in which the motion of rocket performs. The surface can become as chosen surface by producing appropriate rotation of rotating body. This effect is produced by appropriate resultant vector, i.e. vectors of centrifugal force. Its attributes are created by velocity of rotation of rotational body and by position taken when corresponding rotation is reached. This surface of rotating body has attributes of “blocked surface” and of “blocked angle of surface”. The position of this surface does not change during motion. Rotating body keeps to its previous surface taken during sufficient rotation. It can be practically in inclined or in horizontal surface. It will not be changed regardless that corresponding surface, in which the rocket body flies, continuously changes. This rotational surface has attributes of surface with fixed or of blocked angle. The gyroscope body acts accordingly, i.e. in direction of resultant vector or in horizontal surface.

In case of the subjected gyroscope velocity of point placed at end of radius belonging to rotating body is about 60 m/s and it can be denoted here approximately with 6 g, where g=9.81 m/s² (in accordance to that 9.81 m/s² multiplied by 6 is near to value of 60). The rotation of rotational body is 23 thousand of revolutions per minute and it corresponds to 383 revolutions per second. This velocity at end of radius is determined by r=2.5 cm and by:

v=2rπ×383 revolutions=2×2.5×3.14×383=60 m/s.

Approximately an effect of resultant vector is produced by proportion:

$$mass of rotating body \times \frac{velocity at the end of radius of rotating body}{9.81}$$

$$60 grams \times \frac{60}{9.81} \approx 360 grams$$

When velocity at mentioned point of rotating body is 2 g (2×9.81) the resultant vector refers to double mass of rotating body. The resultant vector is approximately expressed with this proportion. This similar proportion can be got by comparison of relations present in a mechanical gyroscope.

Resultant vector expressed in quantity of mass is not recognized in valid physics even as a category. Effects of force are manifested in newtons. As it is said in previous part of the text of application it is necessary to evaluate effects of forces by quantity of mass and by relations between appropriate vectors. Effect of rotating body presented in FIG. 6 is expressed by quantity of mass of the gyroscope body. Acceptance of this result is possible only by introducing with physics definitions previously presented in the text of the application. Centrifugal force can be expressed in units of mass. From this point it is apparent that body of this gyroscope presented by FIG. 6 does not react in accordance with influence of gravitational attraction. The whole rotating body positioned practically in inclined or in horizontal surface acts against influence of gravitational attraction in appropriate rate in conformity with magnitude of velocity present in rotation. This effect appears by rotating velocity and by resultant vector of rotation and of centrifugal force. The more mass a rotating body has, this action is greater.

The presented effect is visible also in one another experiment made by using a mechanical gyroscope. The mentioned educational device produced from Leybold, Germany and previously described is taken into consideration in this experiment.

On the beginning of experiment the gyroscope was put in position depicted by FIG. 7. In this case gyroscope is positioned in a way that a rotational body has smaller torque than a weight put on another side of connected bar. We will say that it is lighter of weight. Now, the next step in the experiment relates to rotation of the rotational body. Rotation is performed by help of a hand and by keeping the connected bar in horizontal position. In the moment when appropriate rotation is achieved and when the hand is removed from gyroscope the connected bar continues to stay in the same horizontal position. This effect is presented by FIG. 8. Influence of gravitational attraction is significantly annulled in this balance but not in all its other manifestations, like through pressure of the device on surface on which is placed.

If rotational body would be rotated when its connecting bar is in position as they are presented in FIG. 9 the connecting bar will not return to previous position during time in which rotation endures. Resultant vector from centrifugal force prevails upon vector of gravitational attraction. Before rotation of the rotational body the connecting bar was in position depicted in FIG. 7. After rotation and with handy adjustments the connecting bar keeps its position presented in FIG. 9. This handy adjustment relates to keeping the connecting bar in position presented in FIG. 9 only during time of rotation of rotational body.

In both cases presented in FIG. 8 and FIG. 9 the rotating body is not in balance, i.e. in equilibrium with weight located on another side of connected bar. It is lighter of weight. But, with appropriate rotations it stays in horizontal position and even in position as it is heavier of weight. Particular power from rotating body has arisen. With originating this power gravitational attraction is annulled in this respect. It is annulled by intensity of resultant vector. It is expressed in quantity of mass.

Property of rotating body is clearly expressed by a mentioned experiment. Rotating body expresses its independent power in rotating surface. It is produced by rotation. This surface becomes blocked surface and angle of rotation becomes blocked angle of surface. Intensity of the resultant vector is greater of intensity of vector symbolized gravitational attraction. This is reason that rotating body built as a part of mechanical gyroscope keeps its position regardless of unbalance that is present between it and weight positioned in another side of the connected bar. It acts against influence of gravitational attraction. This influence is annulled by velocity of rotation of mass of rotational body.

From presented effect of rotation is possible to explain effect depicted with FIG. 10. A longer rod as a shaft is fixed in center of a bicycle wheel. A string is tied at end of the shaft. The wheel is rotated when it is in inclined surface that closes an acute angle with horizontal line. This acute angle is positive angle measured from the positive direction of the axis in coordinate systems of trigonometry and it is presented in FIG. 10. After this operation is completed the end of string will be hanged from the hand. The wheel will stay in inclined surface during rotation. The rotating surface will be in inclined position and the wheel will not fall down during rotation. This surface closes an acute angle with horizontal line. Rotating body in form of bicycle wheel can stays in presented position when its extended shaft is hanged on string. It is “blocked” on inclined surface. Rotating body remains in the same position, occupied during rotation, regardless of influence of gravitational attraction. This is evident case of blocked angle of rotation. Resultant vector of centrifugal force acts against vector of gravitational attraction with dominant influence on creation of position of wheel.

In case of a rotating top a similar effect appears. When it rotates it is obvious that this rotational surface is also blocked. It stays in fixed position during rotation. This surface can be in horizontal or inclined surface. A body of a top does not fall down as it is blocked by rotation. If we put the top during rotation on a scale we see that there is no change in its weight. But, top does not fall down. It acts against gravitational attraction in direction in which its mass is oriented by velocity of rotation. Influence of gravitational attraction is lessened within rotating surface. But mass of rotating body transfers through the body of top, down through axle, and press surface on which it is positioned. Power of rotation excludes influence of gravitational attraction on effect of rotating body only within rotational surface. Mass of rotating body act against gravitational attraction in this surface with appropriate velocity.

Convenience of motion originated from rotating body is presented by FIG. 11. This educational device is produced from Leybold, Germany. A radius of wheel is about 0.4 m. A shaft is in horizontal position. It is connected with center of the presented rotating body. It is hold by a hand. This means that an end the shaft and the wheel are not linked or leaned on any other point except the hand. It rotates in air space. Rotation of the wheel is in vertical surface. Direction in which resultant vector of the rotating body acts is the same as such presented in FIG. 3 and FIG. 4. If rotating body rotates with about two revolutions per second in direction so that resultant vector acts in direction marked with “a” and if rotating body moves in direction marked with “b” this rotating body will move with lessened influence of gravitational attraction. Influence of gravitational attraction is lessened in opposite direction of direction of resultant vector. Resultant vectors act in directions marked with “a”. Mass of rotating body acts in direction of “a”. If the rotational body moves in direction indicated with “b” it will move with small influence of gravitational attraction on it. This effect could not be explained by law that is stipulated in the following way: “When a body A exerts a force on a body B, B exerts an equal and opposite force on A; that is, to every action there is an equal and opposite reaction”. Actions and reactions can be or not be noticed when small velocity is present but a rotational effect will not be manifested in reality with this small velocity. Relations in motion are defined by vectors and resultant vector and with appropriate quantities of masses and velocities.

Similar effect is present in motion in straight line. Mass of body acts only in one direction. It is occupied by velocity only in one direction. Therefore, if rotating body would be moved in opposite direction of direction in which resultant vector acts, it will be under lessened influence of gravitational attraction. If mass of rotational body moves in direction opposite to direction in which resultant vector is aimed this rotating body will move with lessened influence of gravitational attraction. Mass does not act in two directions. It acts in direction in which resultant vector is established. It does not act in direction opposite to direction in which resultant vector is pointed. This property of rotating body is used in the invention. Mass and gravity could not be dismantled but their mutual influence can be subject of control. This effect of convenience in motion originated from rotation appears with resultant vector that is directed in opposite direction of motion. In motion in horizontal straight line mass of body acts only in one direction. If body moves without any presence of rotation in it, resultant vector is aimed in accordance with previous given explanations. According to that, if rotating body moves in direction opposite of direction in which resultant vector acts influence of gravitational attraction on moving body will be lessened.

In action depicted by FIG. 11 three vectors are present as they are:

vector of gravitational attraction,

resultant vector of rotation, i.e. resultant vector of centrifugal force,

vector of motion aimed in opposite direction of action presented by resultant vector.

When body rotates in horizontal surface there is no in this case of rotation any appearance of resultant vector. All parts of rotating body rotate in horizontal surface. All of them act in the same way. Mass of them is oriented in different directions positioned in horizontal surface. Lessening of gravitational attraction is present in all these directions but not in one direction. Appropriate effect appears but it is not in one direction and there is no possibility to use opposite directions for rotational effect.

In rotation in vertical or inclined surface every part of mass is in different position toward influence of gravitational attraction. Resultant vector appears in accordance with previously given explanations.

Effects depicted in previous part of the text of the application can be used in construction of flying object. Lessened influence of gravitational attraction can be used if rotating body positioned in vertical or inclined surface moves in opposite direction of direction in which resultant vector of rotating body acts. Motion of this kind must be in opposite direction of resultant vector of centrifugal force arisen in inclined or in vertical rotation of rotational body. Rotating body can be transformed into a rotational platform. If load is put on the rotating platform an effect of lessening of influence of gravitational attraction will affect load and this effect contributes to fulfillment of presented advantages of the invention.

Coming from fact that magnitude of resultant vector of rotating body positioned in vertical or inclined surface is based on quantity of mass of rotating body and on velocity of rotation it is evident that resultant vector will refer to the whole load on rotational platform. With enlarging resultant vector by load and by increasing rotational velocity rotational effect will appear in effectiveness of the flying object. But, for expressive results velocity of point in middle of radius must be about 2 g.

In fact rotational effect arises in interaction of two systems. One of them relates to motion of flying object and another one to rotational vector. They act to each other. This interchange of actions is equal to similar effects that exist in motion. In FIG. 12 one of them is presented.

The FIG. 12 represents a cannon on a carriage in a moment when a cannon ball is fired from the cannon. Magnitudes are:

Mass of carriage and cannon (m₁) is 20,000 kg.

Velocity of carriage (v₀) is 2.5 m/s

Mass of cannon-ball (m₂) is 23 kg

Velocity (v₂) of the cannon ball is 700 m/s.

The moment before is equal to moment after. Therefore, from

(m₁+m₂)v₀+m₁v₁−m₂v₂ i.e.

M₁v₁=(m₁+m₂)v₀+m₂v₂

it is: v₁=3.3 m/s

Flying object can consist of one rotating platform or of two rotating platforms. Rotational effects will be present by using more than two platforms. They can rotate in the same direction. When two platforms are used and when they rotate in the same direction both contribute to rotational effect. But, one of platform can be at rest in some occasions when rotational effect is needful in moderate level. Contrary to that, two rotational platform can rotate in opposite directions. In this way it is possible to get two effects, one from resultant vector present in one platform which acts in direction of motion and another one from resultant vector which acts in opposite direction of motion. When more than one platform is applied in construction of the flying object one of them can be intended for creation of artificial gravitational attraction. It is needful in inter-planetary flight.

It is possible to construct flying object in which a cover rotates. This rotation will contribute to additional rotational effect.

With application of two platforms it is possible provide access to load placed on a platform during time that it rotates. This access can be provided in two stages. In the first stage crew will enter on a second platform when it is at rest. After that during the second stage when it is rotated with velocity of second platform they will enter on the platform with load. This approach can be suitable in particular circumstances.

Attributes of a rotational effect are relevant for solution in technique of aerial navigation of flying object.

Rotating body produces power within rotational surface. Its intensity can be significant if mass is of rotating body is extensive and if velocity in rotation is immense. Volume of power is relevant in comparison to mass of flying object and in comparison to effects and consequences that can appear in flying. Power of blocked rotational surface must be respect in aerial navigation. Changes in direction of motion can come in collision with rotational effect. Therefore it is necessary to adjust all technical solutions in flying object and all flying rules to this power of rotational effect. In this purpose one of solution for controlling rotational power will be given in continuation of this text as illustrative model for navigation.

Essential rule in navigation is in adjusting an angle of direction of flight with an angle of rotation. It can be made by determination the angle of flight before rotation of rotating body begins. Change of the angle of flight must be made when rotational body is not in rotation. Therefore, when rotation of rotational body is present and when it is necessary to change the angle of flight the first step in this process relates to stopping of rotation.

Taking off and appearance of rotational effect can be accomplished through two stages. During the first stage a rotational body will not be rotated. Within this stage a flying object will take off. After chosen time, for example this time can be until flying object is on height between 100 m and 500 m, the second stage can begin. The flying object can determine an angle of flight. In this moment command for rotation of the rotational body can be given. The second stage is completed when appropriate velocity of rotation is reached. Rotation will be stopped again when appropriate height is reached. In this moment is possible to continue flight in horizontal line. But, in this moment the flying object must take position that the rotational body is in vertical surface. In this respect construction of seats had to be solved in the way that crew and passengers could keep all time their vertical positions. This is achievable by enabling automatic operation of adjusting seats for 90° during time in which horizontal surface of the rotational body is modified to vertical position. According to previous explanations rotation of the rotational body will enable particular effects in motion. Flight can be now directed in straight line. When the flying object reaches desired maximal velocity rotation can be stopped. After this moment the flying object can continue navigation without danger that any collision with rotational power can take place. The rotational body at rest during flight does not produce any power. Achieved velocity of the flying object can be sustained in further motion by power of jet engine.

Advantage of rotation of rotating body can be used in horizontal line for specific purposes. Flying object can get favorable opportunity to keep appropriate horizontal position. In this respect it is necessary to direct streams of a separate jet engines down to vertical line. Blocked rotational horizontal surface supports this effect. This effect can be used in some occasions, like in floods, fires, etc.

During motion of the flying object presented in FIG. 13 rotation of the platform placed in the flying object creates lessening of the influence of gravity on the platform and the loads on the platform when it is moved during flying in particular direction. This rotational effect improves the efficiency of flying.

### BRIEF SUMMARY OF THE INVENTION

The flying object presented in FIG. 13 consists of a body and of other parts. The body of the flying object consists of three main pieces, i.e. from a base and a platform that rotates during a flight, about a particular shaft of rotation, and a cover. The platform rotates parallel to the base. The flying object possesses two kinds of motion during a flight, i.e. the motion of flying and the rotational motion of the platform.

Advantages of the flying object are expressed with rotational effect. It appears in motion of the flying object when direction of rotation of the platform and its angle of rotation is determined in particular way. For appearance of rotational effect is necessary to fulfill two conditions. One of them relates an angle of rotation. It must be in vertical or in inclined surface. Vertical surface exists when the platform is positioned vertically downwards to the horizon, i.e. in direction of action of gravitational attraction. In this respect it is necessary to have in view that definition for horizontal surface is accordingly defined: horizontal surface closes right angle with vertical surface, i.e. with a radius of the earth. Inclined surface closes different than right angle with vertical or horizontal surface, i.e. it deviates from the vertical or horizontal surface. The mentioned second condition for appearance of rotational effect relates to direction of flying. It must be in opposite direction of direction in which it is aimed resultant vector of centrifugal force of the rotating platform. Direction of resultant vector of centrifugal force derives from rotation of the platform. This dependence of resultant vector from direction of rotation is presented by FIG. 3. Therefore, rotational effect will be present when the platform rotates in vertical or in inclined surface and when direction of motion of the flying object is opposite to direction in which it is pointed resultant vector of centrifugal force produced from rotation of the platform. In this respect it is assumed that there is no resultant vector from rotation of the platform in horizontal surface.

### BRIEF DESCRIPTION OF THE SEVERAL VIEWS OF THE DRAWINGS

FIGS. 1-12 are a diagrammatic illustrations of the proposed physics underlying the flying object of the present invention.

FIG. 13 is schematic view of the flying object of the present invention.

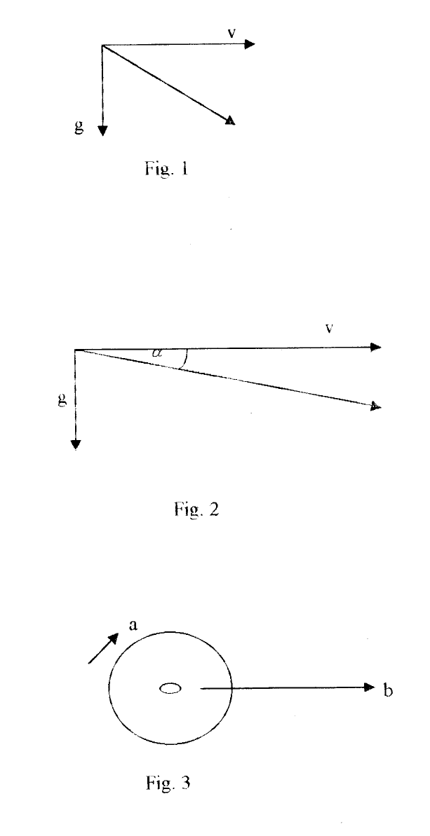

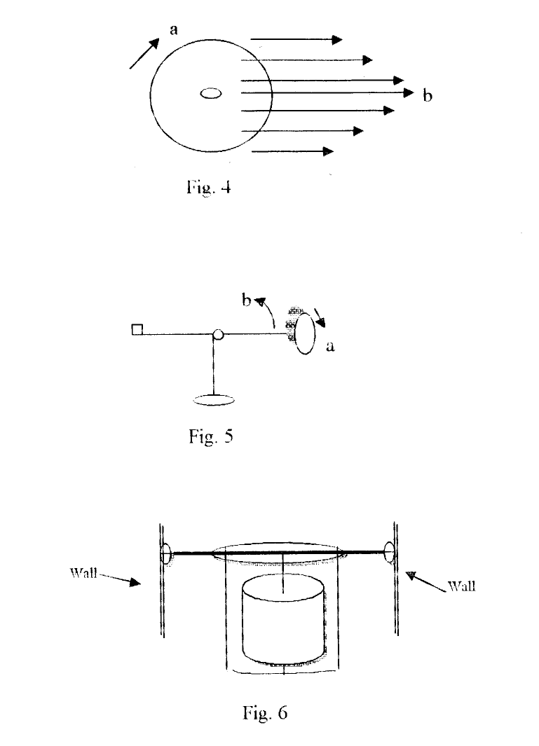

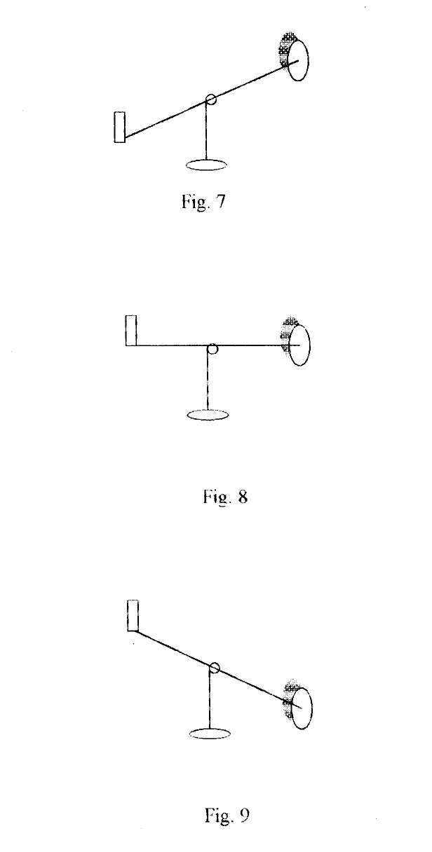

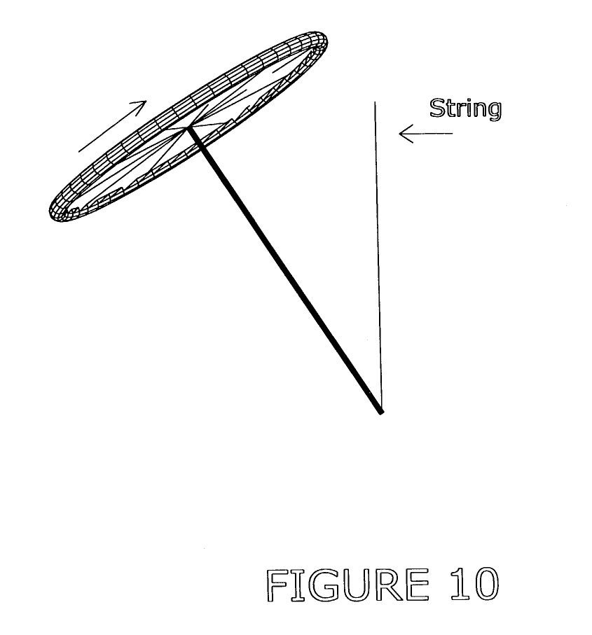

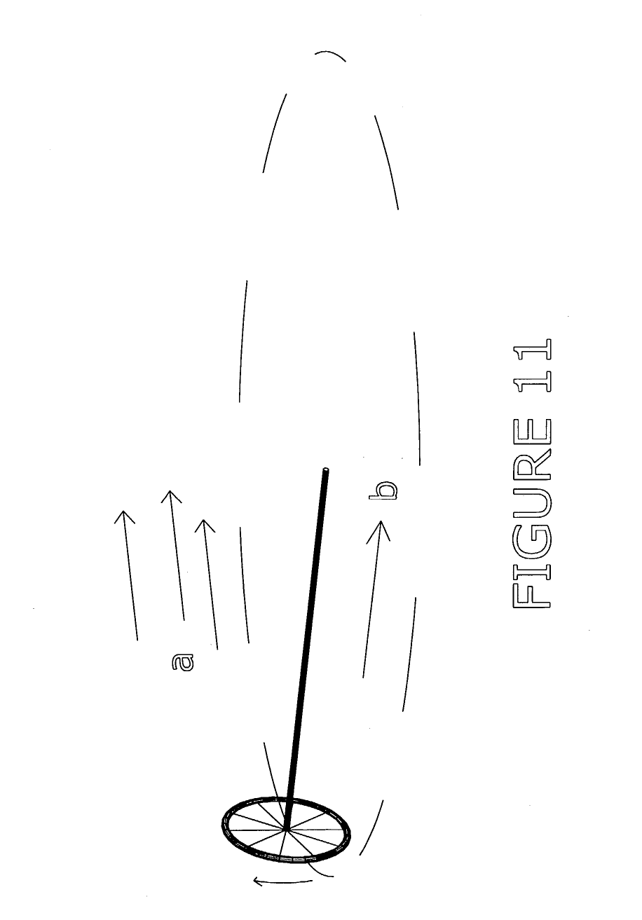

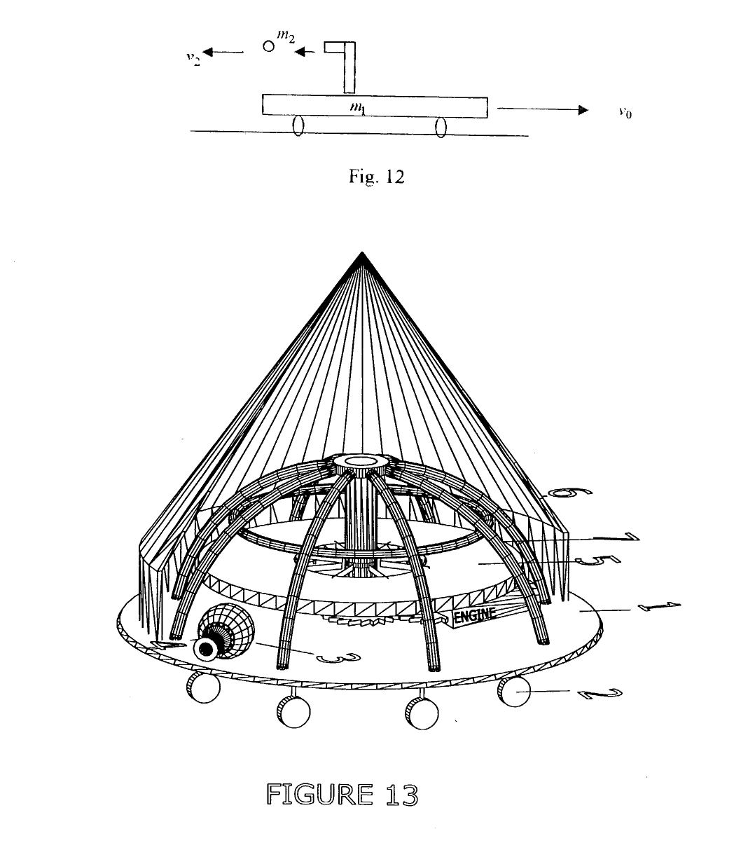

The parts of the flying object which are chosen to be presented in the FIG. 13 represent essential components of the flying object which are of importance for demonstrating the efficiency of the applied invention. These fractions of the figure relate to three pieces of the body, engine for rotation, bearing frame for shaft, jet engine, eight wheels needed for starting motion of the flying object and for landing and to an outlet of a jet engine. The eight wheels increase the mobility of the flying object when moving on land.

### DETAILED DESCRIPTION OF THE INVENTION

The body of the flying object consists of three pieces, as it is depicted in FIG. 13, having the base marked in the FIG. 13 with 1, the platform marked with 5 and the cover marked with 6.

The rotation of the platform marked with 5 is produced with work of engine marked as “ENGINE”. The cover marked with 6 is fixed to the base. The attributes of engine are similar to characteristics of those engines that are customarily used for other rotational purposes. They are similar to characteristics of the engines for trucks, for other vehicles or for vessels, i.e. to attributes of other kinds of engines of the same category. This engine is designated in the further text as the engine for rotation.

A power and a force of the engine for rotation are transmitted over a shaft to the rotational platform. The engine for rotation is fixedly connected to the base. The bearing frame for shaft marked with 7 provides stability in rotation of the shaft.

The main construction material is metal. The shape of the base and of the platforms is circular. The cover is shaped in the form of a lateral surface of a cone or as halves of a sphere or spherical sector, etc.

The platform (5) provides conditions for loading. The fuel is placed in the platform (5).

The achievements of the effects of the flying object, such as they are presented previously, depend on the level of the reached speed of the rotational body. The representing speed of the platform is the speed of the middle point placed in the middle of the distance between a shaft and a rim of the platform, i.e. the speed of the middle point on a radius of the platform. When this speed is near to 20 m/s the results will be moderate, when it is 30 m/s they will be successful, when it is close to 50 m/s they will be excellent.

The flying object moves by effects produced with the jet engine marked with 3. The outlet of the jet engine is presented in the FIG. 13 with a number 4. The jet engine provides exclusively flight power. The jet engine, fixed on the base, makes the flying object take off, fly and has connection to outlet. The function of the jet engine is based on the same principle of jet engines of prior art. The jet engine does not rotate the platform.

The wheels are marked in the FIG. 13 with number 2. They rotate freely, i.e. without any connection with the engine for rotation or with the jet engine.

The cover (6) is fixed to the base (1). It is necessary to provide a separate protection from a difference of pressures, temperatures and quantity of oxygen inside and outside the flying object. In this respect it is convenient to set a cabin for accommodation on the base (1) made from a transparent material and shaped as a lateral surface of a cone covering the whole base. This cabin will provide this protection. The radius of the platform, i.e. the radius of the cover is determined with the chosen dimensions of the flying object. The distance between the platform (5) and a top point of the cover (6) is determined with criteria for stability of the flying object and in accordance with determined purpose of use of the flying object. In this respect the flying object for the use as a space ship can have a larger magnitude of the radius than when the flying object is to be used for other purposes.

The main efficiency of the subjected flying object originates from the rotational motion of the platform and from relation between direction of the rotation and direction of flying. The invention relates to this effectiveness. Improvements and developments of functions of this flying object can be reached by installing more than one platform, by rotation of the cover, by installing more than one jet engine and more than one engine for rotation and by enlarging rotational effect to the whole mass of the flying object. They will have a meaning of improvement of this invention. In this respect they can relate to all solutions regarding to functioning of the parts of the flying object and to other alternative solutions but not to main characteristics of the flying object. The improvements of the patent should be introduced with acquired experiences in its application. However, a more precise experiences in a field of stability and vibration of object are necessary for application of such solution.

I claim:

1. A flying object with a rotational effect comprising:
a base,
a plurality of eight wheels positioned on said base and suitable for starting and landing the flying object,
a platform rotatable parallel to said base,
a bearing frame for shaft,
a cover fixed to said base
an engine fixed to said base by which rotation of said platform is provided,
a jet engine means fixed on said base for starting and taking off, flying and landing the flying object, and
an outlet of said jet engine means,
wherein rotations of said platform provides rotational effect during flight,
wherein the rotational effect appears when direction of motion of the flying object is opposite to a direction of a resultant vector of centrifugal force produced from the rotating platform and when rotation of the platform is on a vertical or inclined surface, the vertical surface being between lines which are pointed downwards to a horizon and that inclined surface deviates from the vertical or horizontal surface and
wherein the resultant vector of centrifugal force of the rotating platform is not present when the platform rotates in the horizontal surface.
